(19) United States
(12) Patent Application Publication
(10) Pub. No.: US 2006/0055207 A1
(43) Pub. Date: Mar. 16, 2006

(54) Floor structure of a motor vehicle

(75) Inventor: Oliver Reinhardt, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/138,212

(22) Filed: May 27, 2005

(30) Foreign Application Priority Data
May 28, 2004 (DE) 10 2004 026 299.3

(51) Int. Cl. B62D 25/20

(52) U.S. Cl. 296/193.07

(57) ABSTRACT

A floor structure of a motor vehicle with a main floor which is divided into two main floor halves in the longitudinal direction of the vehicle by a center tunnel containing a center tunnel reinforcement. In order to create a floor structure which has great rigidity and low weight, the center tunnel is bridged by several reinforcing struts which are rigidly attached to the center tunnel.

This application claims the priority of German Patent Document No. 10 2004 026299.3-43, filed May 28, 2004, the disclosure of which is expressly incorporated by reference herein.

### BACKGROUND AND SUMMARY OF THE INVENTION

The invention concerns a floor structure of a motor vehicle with a main floor which is divided into two halves by a center tunnel containing a center tunnel reinforcement in the longitudinal direction of the vehicle.

DE 195 31 957 C2 discloses a motor vehicle bodywork structure is known which contains a left and right B column, roof side rails running in the longitudinal direction of the vehicle, side ties running in the longitudinal direction of the vehicle, a center roof strut running in the transverse direction of the vehicle and connected to the B columns and the roof side rails, a floor panel and a center tunnel on the floor panel running in the longitudinal direction of the vehicle. The known bodywork structure also has stiffeners running in the transverse direction of the vehicle and connected at an outer end to the lower ends of the B columns and the side ties, with each stiffener having at least one U-shaped channel and a closed cross-section which is provided in the stiffener and formed by the U-shaped channel and the floor panel. The known bodywork structure also has a tunnel reinforcement which is connected to each stiffener and to the center tunnel under the center tunnel. The known bodywork structure also has connecting pieces for connecting the center roof strut to the B columns, with a continuous closed cross-section structure being formed by the B columns, the center roof strut, the stiffeners and the tunnel reinforcement. DE 196 27 610 C2 discloses a vehicle floor is known with a crossbeam arrangement which has a crossbeam profile placed on the vehicle floor and rigidly connected to the vehicle floor at a vehicle seat level and supported at an outer support point on a side tie and at an inner support point on a center tunnel. The known vehicle floor is characterized in that the crossbeam arrangement has an added bracing structure which forms a strong connection with the crossbeam profile and is placed on the vehicle floor and is supported at another support point on the center tunnel provided at a distance from the inner support point. DE 44 42 741 C2 discloses a floor structure for an automobile is known with two longitudinal beams extending over almost the entire length of the vehicle, between which several box channel beams arranged behind one another in the longitudinal direction of the vehicle. The known floor structure is characterized in that each box channel beam is rectangular in shape and is composed of box sections arranged on edge, is connected rigidly to the longitudinal beams with its side box sections and is provided with two diagonally running and crossing reinforcing struts which are arranged on edge in the box channel beam, with the height of the reinforcing struts corresponding to the height of the box sections. DE 42 32 574 A1 discloses a torsion-proof vehicle underbody is known with a four-sided beam arrangement, of which two opposing tips lie in the longitudinal axis of the vehicle and with two beams connected to the four-sided beam arrangement running diagonally to the longitudinal axis. The known vehicle underbody is characterized in that the beams form a cross-like beam arrangement and are rigidly connected to each other at their intersection which coincides at least roughly with the center point of the four-sided beam arrangement.

It is the task of the invention to create a motor vehicle floor structure with a main floor which is divided into two halves by a center tunnel in the longitudinal direction of the vehicle containing a center tunnel reinforcement, this structure being highly rigid, in particular torsion-proof, and low in weight.

With a motor vehicle floor structure with a main floor which is divided into two halves by a center tunnel in the longitudinal direction of the vehicle containing a center tunnel reinforcement, the task is fulfilled by bridging the center tunnel with several reinforcing struts which are connected rigidly to the center tunnel and do not run in the transverse direction of the vehicle only. The open cross-section of the center tunnel which preferably has an essentially U-shaped cross-section is closed by the reinforcing struts, which greatly increases torsional rigidity. Compared to a reinforcing plate attached to the center tunnel, the reinforcing struts have the advantage that they prevent the negative thermal effect of the vehicle's exhaust system.

A preferred embodiment of the floor structure is characterized in that the reinforcing struts are designed as compression-tension struts. This has the advantage that only one preferably diagonally arranged reinforcing strut has to be arranged over a longitudinal section of the center tunnel.

A preferred embodiment of the floor structure is characterized in that at least two reinforcing struts are attached to the center tunnel as a pair diagonally to each other. The reinforcing struts are preferably bolted to the center tunnel and the main floor at their ends. They may also, however, be attached to the center tunnel and main floor in another way.

Another preferred embodiment of the floor structure is characterized in that several reinforcing struts are each arranged in pairs diagonally to each other in a longitudinal section of the center tunnel in each case. Connecting areas designed as flanges, for example, are preferably provided for the main floor halves on the center tunnel. The connecting areas of the center tunnel are connected together by two crossed reinforcing struts each in a longitudinal section also called a field.

Another preferred embodiment of the floor structure is characterized in that the reinforcing struts are designed as pure diagonal ties. If the reinforcing struts are only under a tensile load, their cross-section can be reduced, which has a beneficial effect on the required construction space (ground clearance) of the struts and on the overall weight of the vehicle.

Another preferred embodiment of the floor structure is characterized in that the center tunnel is bridged by at least one cross-strut of which the ends are each arranged at an end of a reinforcing strut. The cross-struts are preferably laid out as compression struts.

Another preferred embodiment of the floor structure is characterized in that the center tunnel is bridged by a transmission bridge of which the ends are each arranged at an end of a reinforcing strut. The transmission bridge can be used as a field boundary. The reinforcing struts then act as a support for the transmission bridge in the event of an accident.

Another preferred embodiment of the floor structure is characterized in that the reinforcing struts are made of metal. The diagonal ties may, for example, be made of steel or aluminum.

Another preferred embodiment of the floor structure is characterized in that the reinforcing struts are made of a fiber-reinforced material. The fiber-reinforced material is preferably plastic reinforced with fiberglass and/or carbon fiber.

In a motor vehicle, and especially in an automobile, the task indicated above is fulfilled by a previously described floor structure.

Other objects, advantages and novel features of the present invention will become apparent from the following detailed description of the invention when considered in conjunction with the accompanying drawings.

Other advantages, features and particulars of the invention can be derived from the following description in which an embodiment is described in detail with reference to the diagram. The features mentioned in the claims and in the description can be essential to the invention each in its own right or in any combination.

### BRIEF DESCRIPTION OF THE DRAWINGS

FIG. 1 represents a floor structure according to the invention perspectively.

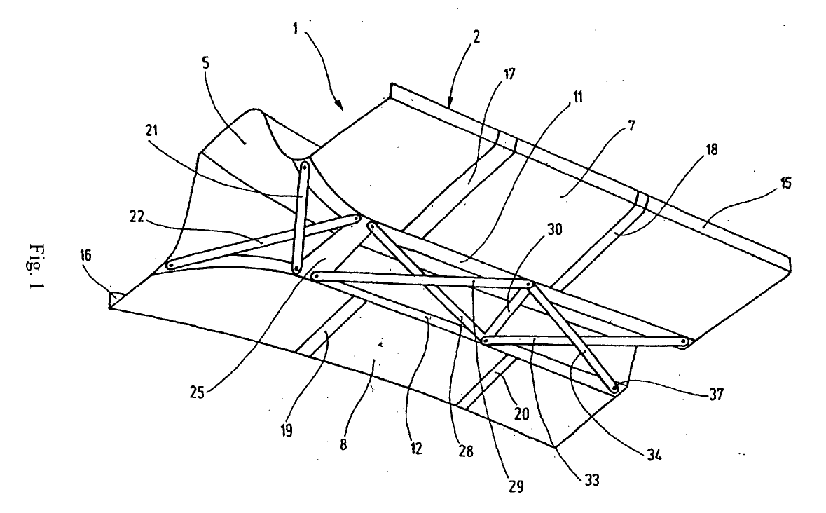

### DETAILED DESCRIPTION OF THE DRAWINGS

The appended FIGURE shows floor structure 1 with main floor 2 which has essentially the form of a flat plate. Main floor 2 is divided by center channel 5 into two main floor halves 7, 8. Main floor half 7 is also called the left main floor half. Main floor half 8 is also called the right main floor half. Center tunnel 5 serves, for instance, to receive a shaft, in particular a drive shaft, which serves to transfer power.

Floor structure 1 is also called the platform frame. Connecting areas 11 and 12 are formed on center tunnel 5 for main floor halves 7 and 8. Connecting areas 15, 16 for longitudinal beams (not shown) are provided on main floor halves 7 and 8 at the outside on the sides. Crossbeams 17, 18; 19, 20 are also attached to main floor halves 7, 8. The longitudinal and cross beams, and the center tunnel, which is also called the center beam, are preferably welded rigidly to the main floor halves to form a platform frame.

Two reinforcing struts 21, 22 are attached crosswise to connecting areas 11, 12 at the front end of center tunnel 5. The ends of reinforcing struts 21, 22 are attached both to center tunnel 5 and to main floor halves 7, 8 in connecting areas 11, 12, by bolted connection for example.

Transmission bridge 25 is arranged at the rear end of reinforcing struts 21, 22, viewed in the longitudinal direction of the vehicle. Transmission bridge 25 is arranged between connecting areas 11, 12 of center tunnel 5 and reinforcing struts 21, 22. Transmission bridge 25 can by bolted to the center tunnel and main floor halves 7, 8 by the same bolts by which reinforcing struts 21, 22 are attached to center tunnel 5 and main floor halves 7, 8. The section of center tunnel 5 which is bridged by reinforcing struts 21, 22 is also called a field which is bounded by transmission bridge 25 in the longitudinal direction.

Reinforcing struts 21, 22 are attached to one side of transmission bridge 25. On the other side of transmission bridge 25 there are two ends of two more reinforcing struts 28, 29 which are also arranged crosswise over center tunnel 5 and are attached with their ends to connecting areas 11, 12 of the center tunnel and main floor halves 7, 8. The other ends of reinforcing struts 28, 29 are connected in the area of cross strut 30 which bridges center tunnel 5 diagonally to the longitudinal direction of the vehicle and parallel to transmission bridge 25.

Cross strut 30 is supported on two opposing sections of connecting areas 11, 12 on which the rear ends of reinforcing struts 28, 29 and the front ends of reinforcing struts 33, 34 are also supported. Cross strut 30 and reinforcing struts 28, 33 and 29, 34 can be attached in each case by a single bolt connection. as is indicated in each case by a dot. The rear ends of reinforcing struts 33, 34 are attached to the rear ends of connecting areas 11, 12. A bolted connection is indicated by dot 37.

By incorporating the diagonally running reinforcing struts which are diagonally stressed, the center tunnel is closed in the area of the floor with a thrust-bearing mechanical structure. In this way, two crossed reinforcing struts connect, each in one field, the two connecting areas of the center tunnel to the main floor under the drive shaft and exhaust system. The transmission bridge is used as a field boundary. Front reinforcing struts 21, 22 act to support transmission bridge 25 in the event of an accident.

The open cross-section of center tunnel 5 is closed by the use of the reinforcing struts. Center tunnel 5 closed by the reinforcing struts has a much improved torsional stability. In particular, in open vehicles such as, for example, roadsters or cabriolets, this causes an efficient increase in the inherent rigidity of the shell without any harmful enlargement of the required construction space such as, for example, when the tunnel structure space is enlarged in the inside of the vehicle. The reinforcing struts are designed as pure diagonal ties, which makes possible a design that optimizes weight and cost.

No thermal damage from the exhaust system results from the open configuration. The design of reinforcing struts as assembly parts allows problem-free integration into an existing assembly process.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Floor structure of a motor vehicle with a main floor which is divided into two main floor halves by a center tunnel which contains a center tunnel reinforcement, characterized in that the center tunnel is bridged by several reinforcing struts which are rigidly connected to the center tunnel.

2. Floor structure according to claim 1, wherein the reinforcing struts are designed as compression tension struts.

3. Floor structure according to claim 2, wherein one reinforcing strut bridges one longitudinal section of the center tunnel in each case.

4. Floor structure according to claim 1, wherein at least two reinforcing struts are attached to the center tunnel as a pair diagonally to each other.

5. Floor structure according to claim 4, wherein several reinforcing struts are in each case arranged in pairs diagonally to each other in one longitudinal section of the center tunnel in each case.

6. Floor structure according to claim 4, wherein the reinforcing struts are designed as pure diagonal ties.

7. Floor structure according to claim 4, wherein the center tunnel is bridged by at least one cross strut of which the ends are arranged at one end of a reinforcing strut in each case.

8. Floor structure according to claim 4, wherein the center tunnel is bridged by a transmission bridge of which the ends are arranged at one end of a reinforcing strut in each case.

9. Floor structure according to claim 1, wherein the reinforcing struts are made of metal.

10. Floor structure according to claim 1, wherein the reinforcing struts are made of fiber-reinforced material.

11. Motor vehicle with a floor structure according to claim 1.

12. A floor structure of a motor vehicle comprising a main floor including two main floor halves, a center tunnel which has a center tunnel reinforcement, and a plurality of reinforcing struts which are rigidly connected to the center tunnel, wherein the center tunnel divides the two halves of the main floor, and wherein the center tunnel is bridged by the reinforcing struts.

13. The floor structure according to claim 12, wherein the reinforcing struts are designed as compression tension struts.

14. The floor structure according to claim 13, wherein each reinforcing strut bridges a longitudinal section of the center tunnel.

15. The floor structure according to claim 12, wherein at least two reinforcing struts are attached to the center tunnel and are diagonal to each other.

16. The floor structure according to claim 15, wherein the plurality of reinforcing struts are arranged in pairs diagonally to each other in one longitudinal section of the center tunnel.

17. The floor structure according to claim 15, wherein the reinforcing struts are designed as pure diagonal ties.

18. The floor structure according to claim 15, wherein the center tunnel is bridged by at least one cross strut of which the ends are arranged at one end of a reinforcing strut.

19. The floor structure according to claim 15, wherein the center tunnel is bridged by a transmission bridge of which the ends are arranged at one end of a reinforcing strut.

20. The floor structure according to claim 12, wherein the reinforcing struts are made of metal.

21. The floor structure according to claim 12, wherein the reinforcing struts are made of fiber-reinforced material.

22. A motor vehicle with a floor structure according to claim 12.
